(19) United States
(12) Patent Application Publication
(10) Pub. No.: US 2020/0051006 A1
(43) Pub. Date: Feb. 13, 2020

(54) Automated Beverage Monitoring System

(71) Applicant: GRIG SYSTEMS LLC, Norman, OK (US)

(72) Inventors: James G. Nieto, Norman, OK (US); Nathan Nieto, Breckenridge, CO (US); Gary E. Abdo, Edmond, OK (US); Isaac John Spear, Oklahoma City, OK (US); Robert Hammons, Edmond, OK (US)

(21) Appl. No.: 16/100,392

(22) Filed: Aug. 10, 2018

(51) Int. Cl. G06Q 10/08; G06Q 50/12

(52) U.S. Cl. CPC G06Q 10/087; G06Q 10/06313; G06Q 50/12

(57) ABSTRACT

An automated beverage monitoring system including one or more electronic scale assembly having a scale, a radio frequency identification tag reader, one or more batteries, one or more processors, one or more transceivers for transmitting and receiving wireless data, one or more data storage devices and a user interface. The automated beverage monitoring system also including a radio frequency identification tag that is affixed to a beverage dispenser. The radio frequency identification tag is configured to be read by the radio frequency identification tag reader of the electronic scale assembly when the beverage dispenser is placed on the electronic scale assembly. The automated beverage monitoring system also includes a remote device, such as a computer or mobile smart phone, in wireless communication with the one or more electronic scale assembly.

### BACKGROUND

Restaurants, bars, and other food and drink providers lose significant sums of money each year due to spillage, theft and imprecise and inefficient beverage monitoring and beverage supply chain management systems and methods. Traditional beverage monitoring systems and methods typically track beverage consumption by manually or automatically counting bottles, cans or other containers or by measuring the amount and type of beverage dispensed at or shortly after the point of sale.

Unfortunately, however, these traditional methods and systems are often imprecise, error prone, not fully automated and require significant and costly investment in specialized skill, infrastructure and equipment. Thus, making widespread adoption and use of such traditional methods and systems inefficient and impractical. Further, traditional beverage monitoring systems and methods do not provide real time data, on demand, regarding the availability, consumption, cost and rate of consumption of beverages.

To that end it would be advantageous to provide an improved automated beverage monitoring system that enables users to utilize existing beverage dispensers and to automatically track, monitor and report data concerning the type, use and consumption of beverages. It is to such an improved system, product and to methods for using thereof that exemplary embodiments of the inventive concepts disclosed and claimed herein are directed.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a top view of an electronic scale assembly of an embodiment of an automated beverage monitoring system according to the inventive concepts disclosed herein.

FIG. 2 is a bottom view of an electronic scale assembly of an embodiment of an automated beverage monitoring system according to the inventive concepts disclosed herein.

FIG. 3 is a diagram of an electronic scale assembly and one or more remote device of an embodiment of an automated beverage monitoring system according to the inventive concepts disclosed herein.

FIG. 4 is a diagram of an embodiment of an automated beverage monitoring system application software program running on one or more remote device.

FIG. 5 is a diagram of an electronic scale assembly and dispenser of an embodiment of an automated beverage monitoring system according to the inventive concepts disclosed herein.

FIG. 6 is a bottom view of a beverage dispenser of an embodiment of an automated beverage monitoring system according to the inventive concepts disclosed herein.

FIG. 7 is a side view of a plurality of electronic scale assemblies stacked in accordance with an embodiment of an automated beverage monitoring system according to the inventive concepts disclosed herein.

FIG. 8 is a diagram of an embodiment of an automated beverage monitoring product according to the inventive concepts disclosed herein.

FIG. 9 is a diagram of an embodiment of an automated beverage monitoring method in a computer according to the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a system, process, method, article, or apparatus that comprises a list of elements is not necessarily limited to only those elements but may include other elements not expressly listed.

The notation “a-n” if appended to a reference numeral is intended as merely convenient shorthand to reference one, or more than one, and up to infinity, of the element or feature identified by the respective reference numeral (e.g., 100a-n). Similarly, a letter following a reference numeral, if used, is intended to reference an embodiment of the feature or element that may be similar, but not necessarily identical, to a previously described element or feature bearing the same reference numeral (e.g., 105, 105a, 105b, etc.). Such shorthand notations, if used, are used for purposes of clarity and convenience only, and should not be construed to limit the instant inventive concept(s) in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The inventive concepts disclosed herein are generally directed to embodiments of an automated beverage monitoring system, automated beverage monitoring computer program product and automated beverage monitoring method in a computer.

For example, the automated beverage monitoring system generally includes one or more electronic scale assembly having a scale, a radio frequency identification tag reader, one or more batteries, one or more processors, one or more transceivers for transmitting and receiving wireless data, one or more data storage devices and a user interface. The automated beverage monitoring system also includes a radio frequency identification tag that is affixed to a beverage dispenser. The radio frequency identification tag is configured to be read by the radio frequency identification tag reader of the electronic scale assembly when the beverage dispenser is placed on the electronic scale assembly. The automated beverage monitoring system also includes a remote device, such as a computer, mobile smart phone, or mobile smart phone software application, for example, in wireless communication with the one or more electronic scale assembly. The one or more remote device having one or more processors, one or more transceivers for transmitting and receiving wireless data and one or more data storage devices.

In some embodiments, the automated beverage monitoring system, also includes a plurality of pegs positioned on a top surface of each scale assembly; and a plurality of sockets positioned on a bottom surface of each scale assembly. The plurality of sockets for receiving a plurality of pegs therein, such that each scale assembly may be detachably connected and stacked for bulk storage and bulk charging of a plurality of scale assemblies.

In some embodiments, the automated beverage monitoring system also includes an automated beverage monitoring system application software program running on the remote device. The automated beverage monitoring system application software program includes automated instructions for configuring the one or more electronic scale assembly to read and identify the one or more radio frequency identification tag affixed to the beverage dispenser, weigh the beverage dispenser in real-time and transmit real-time data associated with the beverage dispenser to the one or more remote device; receiving, from the one or more electronic scale assembly, real-time data associated with the beverage dispenser; correlating the real-time data associated with the beverage dispenser with data stored in a database associated with the beverage dispenser; determining the amount of liquid in the beverage dispenser based on the real-time data associated with the beverage dispenser and the data stored in the database associated with the beverage dispenser; and displaying, on a display screen on the one or more remote device, an indication of the amount of liquid in the beverage dispenser.

The automated beverage monitoring computer program product generally includes a non-transitory storage medium having computer usable program code thereon. The computer usable program code includes: computer usable program code for configuring one or more electronic scale assembly to read and identify one or more radio frequency identification tag affixed to a beverage dispenser, weigh the beverage dispenser in real-time and transmit real-time data associated with the beverage dispenser to one or more remote device; computer usable program code for receiving, from the one or more electronic scale assembly, real-time data associated with the beverage dispenser; computer usable program code for correlating the real-time data associated with the beverage dispenser with data stored in a database associated with the beverage dispenser; computer usable program code for determining the amount of liquid in the beverage dispenser based on the real-time data associated with the beverage dispenser and the data stored in the database associated with the beverage dispenser; and computer usable program code for displaying, on a display screen on the one or more remote device, an indication of the amount of liquid in the beverage dispenser.

The automated beverage monitoring method in a computer generally includes the steps of: configuring one or more electronic scale assembly to read and identify one or more radio frequency identification tag affixed to a beverage dispenser, weigh the beverage dispenser in real-time and transmit real-time data associated with the beverage dispenser to one or more remote device; receiving, from the one or more electronic scale assembly, the real-time data associated with the beverage dispenser, correlating the real-time data associated with the beverage dispenser with data stored in a database associated with the beverage dispenser; determining an amount of liquid in the beverage dispenser based on the real-time data associated with the beverage dispenser and the data stored in the database associated with the beverage dispenser; and displaying, on a display screen on the one or more remote device, an indication of the amount of liquid in the beverage dispenser.

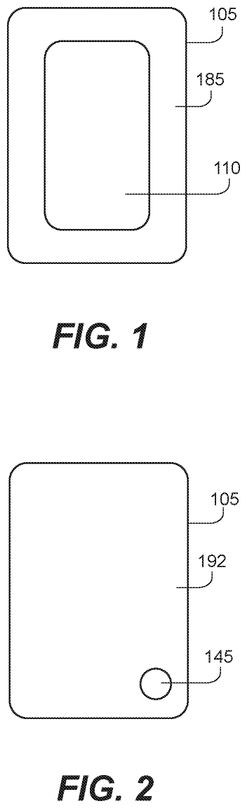

Referring now to FIGS. 1-6 shown therein is an automated beverage monitoring system (100). The automated beverage monitoring system (100) includes one or more electronic scale assembly (105). The one or more electronic scale assembly (105) comprising one or more scale (110), one or more radio frequency identification tag reader (115), one or more batteries (120), one or more processors (125), one or more transceivers (130) for transmitting and receiving wireless data (135), one or more data storage devices (140) and one or more user interface (145). The automated beverage monitoring system (100) also includes one or more radio frequency identification tag (150), wherein the one or more radio frequency identification tag (150) is configured to be affixed to a beverage dispenser (160) and read by the radio frequency identification tag reader (115) of the one or more electronic scale assembly (105) when the beverage dispenser (160) is placed on the one or more electronic scale assembly (105). Further, the automated beverage monitoring system (100) also includes one or more remote device (170) in wireless communication with the one or more electronic scale assembly (105). The one or more remote device (170) comprising one or more processors (125), one or more transceivers (130) for transmitting and receiving wireless data (135) and one or more data storage devices (140).

In some embodiments, the one or more scale assembly (105) further includes a plurality of pegs (180) positioned on a top surface (185) of the one or more scale assembly (105). The one or more scale assembly (105) may also include a plurality of sockets (190) positioned on a bottom surface (192) of the one or more scale assembly (105). The plurality of sockets (190) for receiving a plurality of pegs (180) therein, such that the one or more scale assembly (105) may be detachably connected and stacked for bulk storage and bulk charging of the one or more scale assembly (105) in accordance with the inventive concepts disclosed herein.

In some embodiments, the automated beverage monitoring system (100) further includes an automated beverage monitoring system application software program (200) running on the one or more remote device (170). The automated beverage monitoring system software application software program (200) comprising automated instructions for: configuring (205) the one or more electronic scale assembly (105) to read and identify the one or more radio frequency identification tag (150) affixed to the beverage dispenser (160), weigh the beverage dispenser (160) in real-time and transmit real-time data associated with the beverage dispenser (160) to the one or more remote device (170). The automated beverage monitoring system application software program (200) also includes automated instructions for: receiving (210), from the one or more electronic scale assembly (105), real-time data associated with the beverage dispenser (160); correlating (215) the real-time data associated with the beverage dispenser (160) with data stored in a database associated with the beverage dispenser (160); determining (220) the amount of liquid in the beverage dispenser (160) based on the real-time data associated with the beverage dispenser (160) and the data stored in the database associated with the beverage dispenser (160); and displaying (225), on a display screen on the one or more remote device (170), an indication of the amount of liquid in the beverage dispenser (160).

Referring now to FIGS. 1-2, shown therein is a top view and a bottom view of an electronic scale assembly (105) of an embodiment of an automated beverage monitoring system (100) according to the inventive concepts disclosed herein. FIG. 1 depicts a top surface (185) of the one or more scale assembly (105). FIG. 2, depicts a bottom surface (192) of the electronic scale assembly (105) and a user interface (145) positioned thereon.

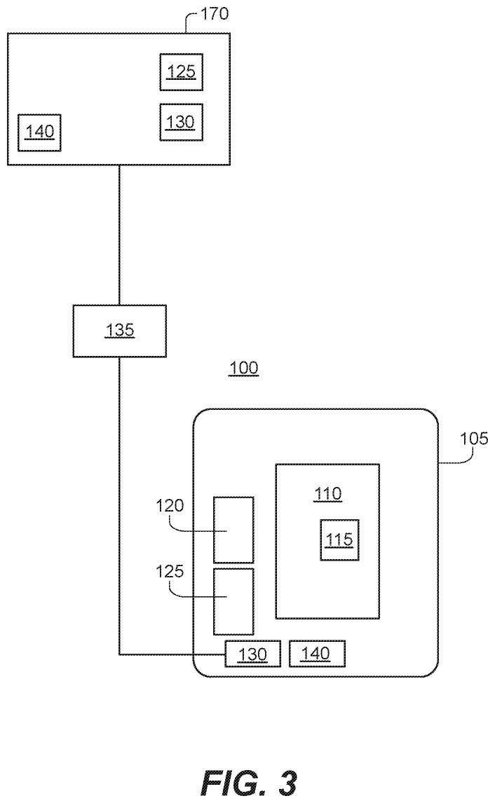

Referring now to FIG. 3, shown therein is one or more electronic scale assembly (105) in wireless communication with one or more remote device (170). The one or more electronic scale assembly (105) includes a scale (110), a radio frequency identification tag reader (115), one or more batteries (120), one or more processors (125), one or more transceivers (130) for transmitting and receiving wireless data (135), one or more data storage devices (140) and a user interface (145).

The one or more electronic scale assembly (105) may be constructed from any type of material sufficient to house the electrical, mechanical and other components necessary to perform the acts described herein. For example, the one or more electronic scale assembly (105) may be constructed from plastics, metals, synthetic materials, combinations thereof and the like for example. The one or more electronic scale assembly (105) may be any desired shape, including a substantially rectangular, square, oval or circular shape for example. The user interface (145) (as shown in FIG. 2) is a button, switch or similar feature sufficient to manually turn the electronic scale assembly (105) on and off. While a manual user on and off button is contemplated, it should be understood that the electronic scale assembly (105) may be turned on and off remotely from the one or more remote device (170) in wireless communication with the one or more electronic scale assembly (105). The one or more remote device (170) comprising one or more processors (125), one or more transceivers (130) for transmitting and receiving wireless data (135) and one or more data storage devices (140).

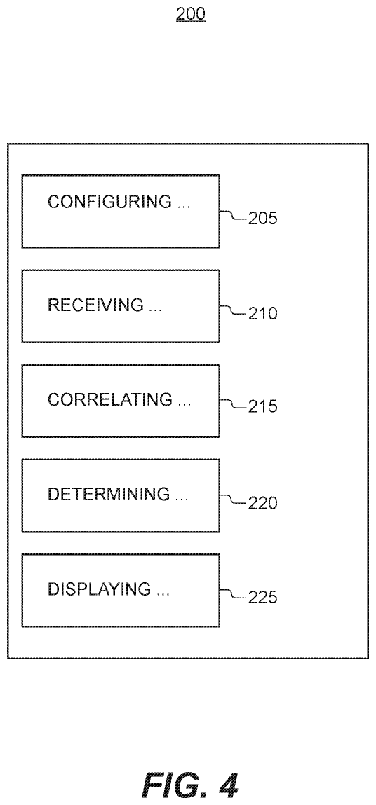

Referring now to FIG. 4, in some embodiments, the one or more remote device (170) also includes an automated beverage monitoring system application software program (200) running on the one or more remote device (170). The automated beverage monitoring system software application software program (200) includes automated instructions for configuring (205) the one or more electronic scale assembly (105) to read and identify the one or more radio frequency identification tag (150) affixed to the beverage dispenser (160), weigh the beverage dispenser (160) in real-time and transmit real-time data associated with the beverage dispenser (160) to the one or more remote device (170).

The automated beverage monitoring system application software program (200) also includes instructions for receiving (210), from the one or more electronic scale assembly (105), real-time data associated with the beverage dispenser (160); correlating (215) the real-time data associated with the beverage dispenser (160) with data stored in a database associated with the beverage dispenser (160); determining (220) the amount of liquid in the beverage dispenser (160) based on the real-time data associated with the beverage dispenser (160) and the data stored in the database associated with the beverage dispenser (160); and displaying (225), on a display screen on the one or more remote device (170), an indication of the amount of liquid in the beverage dispenser (160). The real-time data associated with the beverage dispenser (160) and the stored data may both be stored on one or more physical or virtual servers, which are maintained and controlled by a “cloud” computing provider, for example and such data may be accessed from a software application on a mobile device, such as a mobile phone, for example.

In some embodiments, the automated beverage monitoring system application software program (200), further includes automated instructions for: collecting data related to beverage usage and beverage inventory based on the real-time data associated with the beverage dispenser and the data stored in the database associated with the beverage dispenser; summarizing certain of the data collected related to beverage usage and beverage inventory into one or more selected report format; and generating a report based on the selected report format.

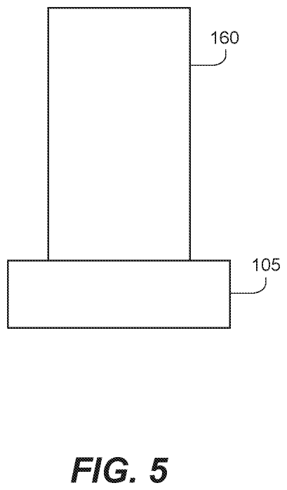

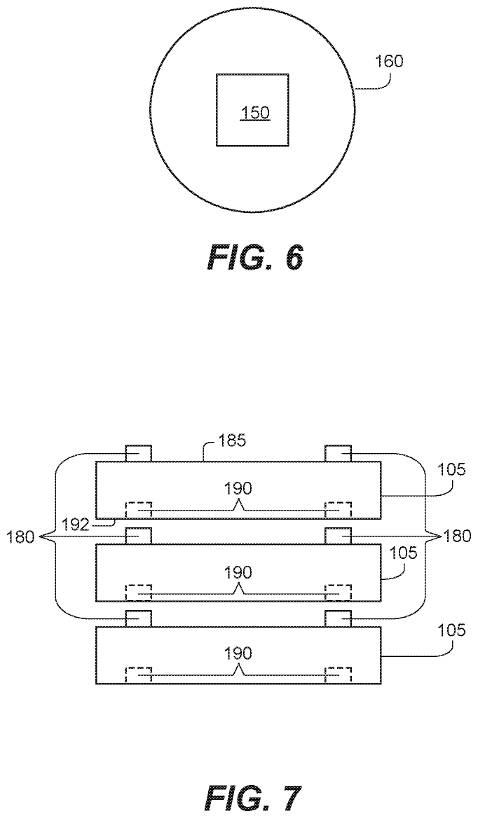

Referring now to FIG. 5, shown therein is a side view of a beverage dispenser (160) sitting on top of an electronic scale assembly (105) of an embodiment of an automated beverage monitoring system (100) according to the inventive concepts disclosed herein. Referring now to FIG. 6, shown therein is a bottom view of a beverage dispenser (160) of an embodiment of an automated beverage monitoring system (100) according to the inventive concepts disclosed herein. The one or more radio frequency identification tag (150) is affixed to the bottom of the beverage dispenser (160). The one or more radio frequency identification tag (150) configured to be read by the radio frequency identification tag reader (115) included within the one or more electronic scale assembly (105). The one or more electronic scale assembly (105) configured to weigh the beverage dispenser (160) in real-time and transmit real-time data associated with the beverage dispenser (160) to the one or more remote device (170).

Referring now to FIG. 7, shown therein is a side view of one or more electronic scale assembly (105) stacked, one on top of another, in accordance with an embodiment of an automated beverage monitoring system (100) according to the inventive concepts disclosed herein. The one or more scale assembly (105) each include a plurality of pegs (180) positioned on a top surface (185) of the one or more scale assembly (105) and a plurality of sockets (190) positioned on a bottom surface (192) of the one or more scale assembly (105). The plurality of sockets (190) for receiving a plurality of pegs (180) therein, such that the one or more scale assembly (105) may be detachably connected and stacked, one on top of the other, for bulk storage and bulk charging of the one or more scale assembly (105).

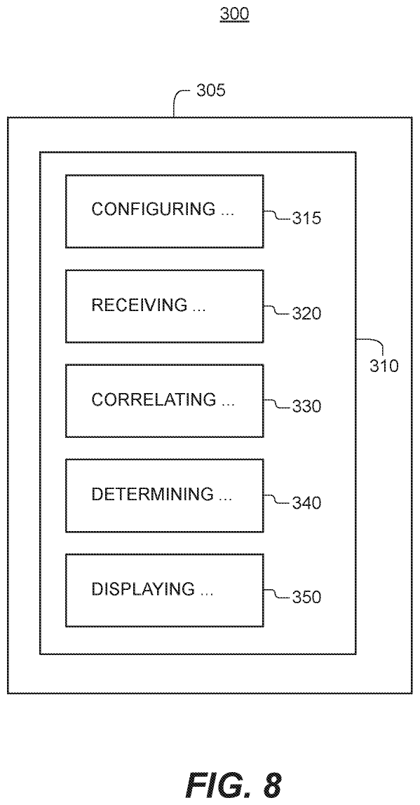

Referring now to FIG. 8, shown therein is a diagram of an embodiment of an automated beverage monitoring computer program product (300) according to the inventive concepts disclosed herein. The automated beverage monitoring computer program product (300), includes a non-transitory storage medium (305) having computer usable program code (310) thereon. The computer usable program code (310) including: computer usable program code for configuring (315) one or more electronic scale assembly (105) to read and identify one or more radio frequency identification tag (150) affixed to a beverage dispenser (160), weigh the beverage dispenser (160) in real-time and transmit real-time data associated with the beverage dispenser (160) to one or more remote device (170).

The computer usable program code (310) further including: computer usable program code for receiving (320), from the one or more electronic scale assembly (105), real-time data associated with the beverage dispenser (160); computer usable program code for correlating (330) the real-time data associated with the beverage dispenser (160) with data stored in a database associated with the beverage dispenser (160); computer usable program code for determining (340) the amount of liquid in the beverage dispenser (160) based on the real-time data associated with the beverage dispenser (160) and the data stored in the database associated with the beverage dispenser (160); and computer usable program code for displaying (350), on a display screen on the one or more remote device (170), an indication of the amount of liquid in the beverage dispenser (160).

In some embodiments, the automated beverage monitoring computer program product (300), further includes, program instructions for: collecting data related to beverage usage and beverage inventory based on the real-time data associated with the beverage dispenser and the data stored in the database associated with the beverage dispenser, summarizing certain of the data collected related to beverage usage and beverage inventory into one or more selected report format; and generating a report based on the selected report format.

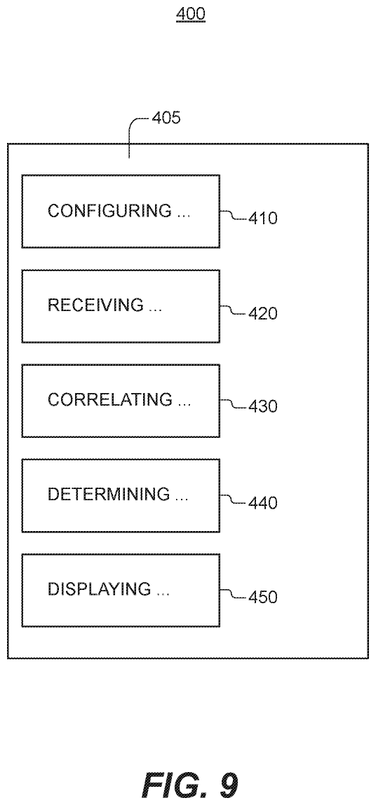

Referring now to FIG. 9, shown therein is a diagram of an embodiment of an automated beverage monitoring method (400) in a computer (405) according to the inventive concepts disclosed herein. The automated beverage monitoring method (400) in a computer (405) includes the steps of: configuring (410) one or more electronic scale assembly (105) to read and identify one or more radio frequency identification tag (150) affixed to a beverage dispenser (160), weigh the beverage dispenser (160) in real-time and transmit real-time data associated with the beverage dispenser (160) to one or more remote device (170); receiving (420), from the one or more electronic scale assembly (105), the real-time data associated with the beverage dispenser (160); correlating (430) the real-time data associated with the beverage dispenser (160) with data stored in a database associated with the beverage dispenser (160); determining (440) an amount of liquid in the beverage dispenser (160) based on the real-time data associated with the beverage dispenser (160) and the data stored in the database associated with the beverage dispenser (160); and displaying (450), on a display screen on the one or more remote device (170), an indication of the amount of liquid in the beverage dispenser (160).

In some embodiments, the automated beverage monitoring method (400), further includes the steps of: collecting data related to beverage usage and beverage inventory based on the real-time data associated with the beverage dispenser and the data stored in the database associated with the beverage dispenser, summarizing certain of the data collected related to beverage usage and beverage inventory into one or more selected report format; and generating a report based on the selected report format.

In some embodiments, the one or more electronic scale assembly (105) is substantially rectangular and is sized to be approximately ¼ inch thick. It should be understood, however, that the one or more electronic scale assembly (105) may be constructed in a variety of shapes and a variety of sizes. For example, the shape and size of the one or more electronic scale assembly (105) may be customized to match the outside boundaries of a horizontal cross section of a particular beverage dispenser, including beverage dispenser (160). The electrical and mechanical components of the one or more electronic scale assembly (105) are configured to be stored inside a housing of the one or more electronic scale assembly (105) to provide a streamlined and intuitively configured device for ease of use.

In some embodiments, the one or more electronic scale assembly (105) may contain few, if any, visible wires, buttons, screens, ports or other types of user interfaces on the top of the device. In one embodiment, the one or more electronic scale assembly (105) contains a single SMD LED that exists on the printed circuit board (PCB). A SMD LED (surface-mounted device light emitting diode) is a type of module that uses surface mount technology to mount LED chips on PCB. A PCB is a non-conductive material with conductive lines printed or etched thereon. Electronic components are mounted on the board and the traces connect the components together to form a working circuit or assembly.

In some embodiments, there will be one blue SMD LED on the PCB which utilizes optics to transfer its light to an outside edge of the one or more electronic scale assembly (105). The blue SMD LED light may act as the status light on the rear edge of the one or more electronic scale assembly (105) which can be enabled, disabled and dimmed for status feedback. The user interface (145) consists of a single button on the bottom of the one or more electronic scale assembly (105) and in some embodiments may contain another SMD RGB (red, green, blue) status LED mounted on the PCB and piped to the bottom surface of the one or more electronic scale assembly (105).

In some embodiments, the one or more scale assembly (105) further includes: a plurality of pegs (180) positioned on a top surface (185) of the one or more scale assembly (105) and a plurality of sockets (190) positioned on a bottom surface (192) of the one or more scale assembly (105). The plurality of sockets (190) for receiving a plurality of pegs (180) therein, such that the one or more scale assembly (105) may be detachably connected and stacked for bulk storage and bulk charging of the one or more scale assembly (105). In some embodiments, the plurality of pegs (180) and the plurality of sockets (190) are metal, such as silver or the like and may be used to conduct electricity for bulk configuration and bulk charging of a plurality of the one or more scale assembly (105).

By way of example, the electrical components for the automated beverage monitoring system (100) may include: a PCB comprising: (4) weight sensor amplifiers; (1) Murata IMP003 (LBWA1Z1CD); (4) TE connectivity weight sensors; (1) U-Blox LTE Cat NB1 GSM Modem (SARA N200); (1) Battery charging and maintaining circuit for a lithium battery; (1) non-replaceable, rechargeable, lithium battery, 1 Ah or greater; (1) floating-point coprocessor; (1) radio frequency identification (RFID) read and write module (Clou CL7206D3); various other supporting components, resisters, capacitors, weight sensors, inductors, diodes, crystals and the like; and a data storage facility in the form of EEPROM. EEPROM stands for electrically erasable programmable read-only memory and is a type of non-volatile memory used in computers, integrated in microcontrollers for electronic devices to store relatively small amounts of data but allowing individual bytes to be erased and reprogrammed for example. The real-time data and the stored data may be stored on one or more physical or virtual servers, which are maintained and controlled by a “cloud” computing provider, for example and such data may be accessed from a software application on a mobile device, such as a mobile phone, for example. The data may be pushed or delivered automatically via the Web and initiated by an information server rather than by the information user, for example.

In some embodiments, the weight sensors used in the automated beverage monitoring system (100) may be positioned equidistant from each other about the center of the load bearing area of the one or more electronic scale assembly (105). Depending on the size and shape of the one or more electronic scale assembly (105), the weight sensors may reside in the relative corners of the one or more electronic scale assembly (105) or in the middle of each side of the one or more electronic scale assembly (105). Each weight sensor may connect to its own weight sensor amplifier for example. From the amplifiers, individual communication via the SPI serial communication protocol is established with the floating-point coprocessor to begin interpreting and recording data to the EEPROM data storage facility. The automated beverage monitoring system (100) may be hard wired or battery operated. The automated beverage monitoring system (100) may use and communicate with other devices using, WiFi, NFC, Bluetooth®, cellular data, combinations thereof and the like, for example. In some embodiments, the automated beverage monitoring system (100) is capable of reading volumes from less than an ounce to more than several pounds, including up to forty pounds, for example.

In some embodiments, the one or more electronic scale assembly (105) contains a variety of wireless communication methods, including but not limited to WiFi, cellular, and Bluetooth® for example. By using a combination of these wireless communication methods and protocols, wireless communication can be established between and among: a remote device (170), such as a mobile device, smart phone, tablet or computer and the one or more electronic scale assembly (105); and one or more electronic scale assembly (105) and another one or more electronic scale assembly (105); and one or more electronic scale assembly (105) and various other computers and devices, for example.

In some embodiments, each of the one or more electronic scale assembly (105) may be positioned either partially or fully enclosed within a housing of a piece of furniture, for example, where beverages are typically stored for use. For example, each of the one or more electronic scale assembly (105) may be positioned in a row or column underneath a ledge or shelf where beverages are typically stored for use. Such that, in use, any number of beverages may be picked up, used, and placed back on the shelf or ledge, in any particular order, and without a user being aware that the one or more electronic scale assembly (105) are located therein. In this way, the automated beverage monitoring system (100) may be implemented to track inventory, beverage use, and monitor employee performance and customer usage of beverages in an unobtrusive manner and without drawing attention or requiring involvement from the customer, employee or user.

In some embodiments, the automated beverage monitoring system (100) will also include the ability to send alerts, notifications, reports, summaries or spreadsheets to certain designated telephone numbers or email addresses, for example, in order to notify a user or a third party that a particular inventory, beverage or other product is empty or close to empty in order to prompt the user or third party to refill, order or change the appropriate beverage dispenser. The automated beverage monitoring system (100) may be configured to output and send certain reports and summaries automatically or upon a pre-set or determined event or amount of time. For example, quarterly reports or summaries may be programmed to be sent automatically, while breakdown charts of beverage usage by beverage type, employee, or other criteria may be sent when requested by a user.

In some embodiments, the automated beverage monitoring system (100) and the automated beverage monitoring system application software program (200) and the automated beverage monitoring computer program product (300) will also include options for setting user permissions for different types of users. For example, employees, bussers, managers, hosts, or owners. Each user permission option may grant different users different access and different options or views appropriate for each such user. For example, an owner may have complete access, while an employee may have limited access to make changes and limited access to view reports, summaries or data. User permissions may also specify notifications to be sent only to certain users or groups of users.

In some embodiments, a user may personalize each employee login to enable tracking of employee performance regarding product downtime, refills, usage rates and various other data. For example, data collection and automated reports and summaries may include: data associated with store location, top sellers, low sellers, and peak and down time periods by user or product, for each day of the week, month or year, for example. Reports and summaries may include time stamps correlated or associated with such data to track performance, usage and various other parameters. Additional reports and summaries may include, for example, inventory lists based upon RFID tags combined with recorded inventory; products which are out of stock, soon to be out of stock and products which are fully stocked.

As will be appreciated by those of ordinary skill in the art having the benefit of the instant disclosure, the automated beverage monitoring system (100) may be shipped with the automated beverage monitoring system (100) fully or partially disassembled in the form of a kit, or fully or partially assembled, as will be readily appreciated by persons of ordinary skill in the art having the benefit of the instant disclosure.

By way of example, in some embodiments, a user of the automated beverage monitoring system (100) will install an automated beverage monitoring system application software program (200) or install an automated beverage monitoring computer program product (300) on a computer or mobile device, such as a smart phone, tablet or the like. The user will then open a package of one or more radio frequency identification tag (150), cleaning wipes and various ID stickers. A user will then affix a radio frequency identification tag (150) to the bottom of the beverage dispenser (160) they wish to monitor and affix an ID sticker to a visible area (front, back or side for example) of the beverage dispenser (160).

The radio frequency identification tag (150) will aid in the beverage dispenser (160) identification method. For example, when beverage dispenser (160) labeled as “Dispenser 6” is set atop the one or more electronic scale assembly (105) and labeled as “Scale A”, the one or more radio frequency identification tag reader (115) of the one or more electronic scale assembly (105) will read the one or more radio frequency identification tag (15) affixed to the beverage dispenser (160) and recognize that it is monitoring Dispenser 6 along with receiving all associated data from the one or more remote device (170), the automated beverage monitoring system application software program (200) or the automated beverage monitoring computer program product (300) for example.

After the beverage dispenser (160) set up is complete, the user will open the automated beverage monitoring system application software program (200) or the automated beverage monitoring computer program product (300), for example and begin to customize the automated beverage monitoring system (100) by answering, simple guided questions like: “How do you want to be notified when a dispenser needs refilling?; Through the app; send a text; send an email; or don't notify me, I'll be checking it. Other questions may include: Should we text/email you or someone else when a dispenser is low?; Someone else (add name, contact info); You (verify contact information).

Once the customization process is complete, the user will begin to add one or more electronic scale assembly (105) to the account. When the user is ready, the user will press the user interface (145) button on the bottom surface (192) of the one or more electronic scale assembly (105) for 1 second then 3 seconds to put each of the one or more electronic scale assembly (105) into “pairing mode”. The automated beverage monitoring system application software program (200) or the automated beverage monitoring computer program product (300) will begin to search for each of the one or more electronic scale assembly (105) and add it to the user's account with its unique ID number.

Once the user has confirmed that all of the desired one or more electronic scale assembly (105) have been added, the automated beverage monitoring system application software program (200) or the automated beverage monitoring computer program product (300) will choose one electronic scale assembly (105) to act as the configuration helper and blink its blue status LED rapidly to identify itself. The user will then use this electronic scale assembly (105) throughout the rest of the set up process.

The user will place each empty beverage dispenser (160) on the “configuration helper” electronic scale assembly (105) where the user will select what ID sticker to affix and set what beverage each beverage dispenser (160) will contain. The automated beverage monitoring system application software program (200) or the automated beverage monitoring computer program product (300) will allow the user to upload pictures of each beverage dispenser (160) if they so choose for positive identification.

At this time the pairing will be complete for that beverage dispenser (160) and the next pairing can be started following the same process until all desired electronic scale assembly (105) are paired as described above. When the setup and pairing process is complete the automated beverage monitoring system application software program (200) or the automated beverage monitoring computer program product (300) will be able to identify each beverage dispenser (160), what electronic scale assembly (105) are associated with the account, how to connect to them, the types and brands of beverages that will be offered and how much each of the empty beverage dispenser (160) weigh.

In some embodiments, each of the one or more electronic scale assembly (105) will have a battery life that will typically last for a week to a month depending on usage and various other factors. The user will take each of the one or more electronic scale assembly (105) and set them where the beverage dispenser (160) will be located. When the one or more electronic scale assembly (105) senses motion it will turn on and initialize for use. Each beverage dispenser (160) can then be set atop any electronic scale assembly (105). The order or match is not important because the radio frequency identification tag reader (115) of the electronic scale assembly (105) will read the radio frequency identification tag (150) affixed on the underside of the beverage dispenser (160) and request all data and attributes of that particular beverage dispenser (160) from the remote device (170), such as a computer or mobile device and from the automated beverage monitoring system application software program (200) or the automated beverage monitoring computer program product (300), for example.

All of the associated data and attributes that are assigned to that beverage dispenser (160) will now be reported through its respective electronic scale assembly (105). The user will now have access to real time data such as current consumption rates, predictive rates, average user fill and estimated time of refill among many other data and features. There will also be an ordering display screen on the automated beverage monitoring system application software program (200) or the automated beverage monitoring compute program product (300), which will guide a user through questions and assist the user in interpreting data to select and order inventory such as beverages and other items.

In some embodiments, the automated beverage monitoring system (100) will also include a charging/interface station that will similarly resemble one or more electronic scale assembly (105). This charging/interface station will have multiple ports along with wireless communication methods for batch firmware updates, power distribution circuits to supply power for recharge of the one or more electronic scale assembly (105). The plurality of pegs (180) and sockets (190) will conduct power along with either a UART or I2C communication protocol to each of the one or more electronic scale assembly (105).

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. An automated beverage monitoring system comprising:
one or more electronic scale assembly, the one or more electronic scale assembly comprising a scale, a radio frequency identification tag reader, one or more batteries, one or more processors, one or more transceivers for transmitting and receiving wireless data, one or more data storage devices and a user interface;
one or more radio frequency identification tag, wherein the one or more radio frequency identification tag is configured to be affixed to a beverage dispenser and read by the radio frequency identification tag reader of the one or more electronic scale assembly when the beverage dispenser is placed on the one or more electronic scale assembly; and
one or more remote device in wireless communication with the one or more electronic scale assembly, the one or more remote device comprising one or more processors, one or more transceivers for transmitting and receiving wireless data and one or more data storage devices.

2. The automated beverage monitoring system of claim 1, wherein the one or more scale assembly further comprises:
a plurality of pegs positioned on a top surface of the one or more scale assembly; and
a plurality of sockets positioned on a bottom surface of the one or more scale assembly, the plurality of sockets for receiving a plurality of pegs therein, such that the one or more scale assembly may be detachably connected and stacked for bulk storage and bulk charging of the one or more scale assembly.

3. The automated beverage monitoring system of claim 1, further comprising an automated beverage monitoring system application software program running on the one or more remote device, the automated beverage monitoring system application software program comprising automated instructions for:
configuring the one or more electronic scale assembly to read and identify the one or more radio frequency identification tag affixed to the beverage dispenser, weigh the beverage dispenser in real-time and transmit real-time data associated with the beverage dispenser to the one or more remote device;
receiving, from the one or more electronic scale assembly, real-time data associated with the beverage dispenser;
correlating the real-time data associated with the beverage dispenser with data stored in a database associated with the beverage dispenser;
determining the amount of liquid in the beverage dispenser based on the real-time data associated with the beverage dispenser and the data stored in the database associated with the beverage dispenser; and
displaying, on a display screen on the one or more remote device, an indication of the amount of liquid in the beverage dispenser.

4. The automated beverage monitoring system application software program of claim 3, further comprising automated instructions for:
collecting data related to beverage usage and beverage inventory based on the real-time data associated with the beverage dispenser and the data stored in the database associated with the beverage dispenser;
summarizing certain of the data collected related to beverage usage and beverage inventory into one or more selected report format; and
generating a report based on the selected report format.

5. An automated beverage monitoring computer program product, the automated beverage monitoring computer program product comprising a non-transitory storage medium having computer usable program code thereon, the computer usable program code comprising:
computer usable program code for configuring one or more electronic scale assembly to read and identify one or more radio frequency identification tag affixed to a beverage dispenser, weigh the beverage dispenser in real-time and transmit real-time data associated with the beverage dispenser to one or more remote device;
computer usable program code for receiving, from the one or more electronic scale assembly, the real-time data associated with the beverage dispenser;
computer usable program code for correlating the real-time data associated with the beverage dispenser with data stored in a database associated with the beverage dispenser;
computer usable program code for determining an amount of liquid in the beverage dispenser based on the real-time data associated with the beverage dispenser and the data stored in the database associated with the beverage dispenser; and
computer usable program code for displaying, on a display screen on the one or more remote device, an indication of the amount of liquid in the beverage dispenser.

6. The automated beverage monitoring computer program product of claim 5, further comprising, program instructions for:
collecting data related to beverage usage and beverage inventory based on the real-time data associated with the beverage dispenser and the data stored in the database associated with the beverage dispenser,
summarizing certain of the data collected related to beverage usage and beverage inventory into one or more selected report format; and
generating a report based on the selected report format.

7. An automated beverage monitoring method in a computer comprising the steps of:
configuring one or more electronic scale assembly to read and identify one or more radio frequency identification tag affixed to a beverage dispenser, weigh the beverage dispenser in real-time and transmit real-time data associated with the beverage dispenser to one or more remote device;
receiving, from the one or more electronic scale assembly, the real-time data associated with the beverage dispenser;
correlating the real-time data associated with the beverage dispenser with data stored in a database associated with the beverage dispenser;
determining an amount of liquid in the beverage dispenser based on the real-time data associated with the beverage dispenser and the data stored in the database associated with the beverage dispenser; and
displaying, on a display screen on the one or more remote device, an indication of the amount of liquid in the beverage dispenser.

8. The automated beverage monitoring method of claim 7, further comprising the steps of:
collecting data related to beverage usage and beverage inventory based on the real-time data associated with the beverage dispenser and the data stored in the database associated with the beverage dispenser;
summarizing certain of the data collected related to beverage usage and beverage inventory into one or more selected report format; and
generating a report based on the selected report format.
